(19) United States
(12) Patent Application Publication
(10) Pub. No.: US 2011/0266376 A1
(43) Pub. Date: Nov. 3, 2011

(54) MISTING DEVICE

(76) Inventor: Frederic Goessens, Vieillevigne (FR)

(21) Appl. No.: 13/144,174

(22) PCT Filed: Jan. 12, 2010
(86) PCT No.: PCT/FR2010/000022

§ 371 Date: Jul. 12, 2011

(30) Foreign Application Priority Data
Jan. 13, 2009 (FR) 0900134

(51) Int. Cl. A62C 31/02

(52) U.S. Cl. 239/589

(57) ABSTRACT

The present invention relates to a fractionating injector, in particular to a Venturi-effect misting unit, of the type comprising a convergent axial vein (3) intended to receive a pressurized gas flow, a cylindrical vein (5) and a divergent axial vein (7), where said injector furthermore comprises at least one secondary vein (9), substantially transverse, intended to admit a liquid flow, and which opens downstream from the convergent vein (3), characterized in that the axis (zz′) of the cylindrical vein 5 is offset in angle compared to the longitudinal axis (xx′) of the convergent (3) and divergent (5) veins. The present invention also relates to injection units and misting devices implementing such an injector.

The present invention relates to a fractionating injector in particular intended to equip injection units of the type of those used on devices for decontamination by misting a disinfection product on surfaces to be treated, and in particular on the walls of a room and the various devices and instruments contained therein. The present invention also relates to misting devices suited to generating and projecting fine droplets into the room to be treated forming therein a mist of the type referred to as “dry mist”.

It is known that bacterial agents which are the cause of contamination and which are suspended in the air in a room have a tendency to settle onto the various surfaces and objects contained therein. It is further known that inversely bacterial agents which develop on the objects and walls in a room (for example operating rooms, clean rooms or various care rooms, etc.) have a tendency to go into suspension in the atmosphere. These rooms are therefore found in a situation of continual exchange between the walls and objects on the one hand and the atmosphere on the other.

Ensuring the overall decontamination, meaning both the atmosphere and various walls and objects of a room, is proposed by spraying a disinfecting product into the volume thereof. It has been observed this kind of disinfection by spraying has several drawbacks.

First, the size of the droplets formed is relatively large (of order 80 to 200 μm for a flow rate of 3 to 5 mL of air per minute), such that droplets deposit on the surfaces near the site of their spraying by simple force of gravity, which of course is not satisfactory to the extent where the surfaces far from the spraying injector go untreated.

Second, because of the large size of the droplets, they have a tendency to combine and form a damp film, even liquid pools, on the surfaces of the walls and objects in the room.

In the patent FR 2,859,650 in the name of the applicant, improving the fractionating of the spray droplets was proposed by making use of an injection unit making it possible to obtain fine droplets whose dimensions are of order 2 μm to 20 μm and which thus have the property of being found in suspension in the entire volume of the room and depositing on the walls and objects contained therein without clumping together so well that they form a continuous film; the mist thus generated is called “dry mist”.

Thus the injection unit according to the patent FR 2,859,650 includes:

a secondary vein connected to the means for supplying said liquid and comprising means for achieving a first fractionating of said liquid and an expansion chamber;

a principal vein connected to means for generating a gas flow comprising means for achieving a second fractionating of said liquid and an outlet orifice to the atmosphere;

means of joining said secondary vein to said principal vein connecting the expansion chamber and the means for achieving the second fractionating of said liquid.

According to a particularly interesting variant of this invention, the injection unit is provided with an ultrasonic “resonator” placed downstream from the injector outlet, such that the flow exiting therefrom finds itself subject to a fragmentation forming a sort of “diffraction” of the drops, having the effect of making them still smaller which makes it possible to further increase the homogeneity of their distribution.

Such an injection unit, while it makes it possible to distribute fine droplets of the treatment product uniformly in the entire volume of a room, however has some disadvantages.

First, the ultrasonic resonator placed downstream from the outlet of the injector must of course be kept in position by a support connected to the misting unit. Hence, it was observed that this support had the effect of causing an uncontrolled diffusion of the exiting spray jet which harmed the proper uniformity thereof. In order to minimize this disadvantage, the support was made as thin as possible, but this made it particularly vulnerable to the shocks and other stresses which it was subject to during use and more so since its position on the top of the device further increased this vulnerability.

It was also observed that during operation droplets of liquid spray accumulated on the support and contributed to the formation of drops of liquid which are sprayed with the fine droplets of the main jet.

Finally, the presence of the resonator in the head of the injector blocked the integration thereof in certain treatment machines in which it was desired to have a complete enclosure of the means of spraying.

The purpose of the present invention is to propose a spray injector suited to generating a dry mist and to distribute it homogeneously and uniformly in the entire volume of a room without it being necessary for all that to make use of an ultrasonic resonator.

Thus the purpose of the present invention is a fractionating injector in particular for a Venturi-effect misting unit, of the type comprising a main vein successively constituted of a convergent axial vein intended to receive a pressurized gas flow, a cylindrical vein and a divergent axial vein, where said injector comprises furthermore at least one secondary vein, substantially transverse, intended to admit a flow of treatment liquid and which opens out downstream from the convergent vein, characterized in that the axis of the cylindrical vein is offset in angle relative to the longitudinal axis of the convergent and divergent veins.

Interestingly, the secondary vein will open out into the upstream part of the divergent vein.

Preferably the angular offset will be included between 2° and 8° and will preferably be near 4°. Furthermore the respective lengths of the convergent vein and divergent vein will preferably be substantially equal. As for the length of the cylindrical vein, it could be equal to about half the length of the convergent vein and, more precisely, of order 0.4 times the length.

According to the invention, the aperture of the convergent vein could be included between 40° and 50° and will preferably be near 46° and the aperture of the divergent vein could be included between 10° and 20° and will preferably be near 15°.

Finally the diameter of the cylindrical vein connecting the convergent and divergent veins could be included between 0.9 and 1.5 mm and be preferentially near 1.3 mm.

The purpose of the present invention is also to propose an injection unit able to implement such an injector.

Thus the purpose of the present invention is an injection unit of the type comprising a body pierced by a cylindrical axial channel supplied, at one of the ends thereof, by pressurized gas flow and receiving at the other end thereof a fractionating injector as previously described, where said body is provided with at least one line for intake of a treatment liquid opening out into a distribution chamber connected with the secondary vein of the injector.

Preferentially the axis of the intake line will be substantially perpendicular to the longitudinal axis of the axial channel. Furthermore the line for intake of the treatment liquid will be advantageously provided in the downstream part thereof with an orifice calibrated for flow rate control.

Finally, according to the invention the distribution chamber could be formed between the outer surface of an insert bearing on the injector which will be pierced by an axial channel for supply thereof by gas flows and the inner surface of a recess made in the body.

Finally the purpose of the present invention is to propose an autonomous misting device suited, after a given operating time interval, to eradicating any bacterial germ either in the atmosphere or on the surfaces of the walls and objects thereof.

The purpose of the present invention is therefore also a misting device comprising a fractionating injector of the type previously described, placed in an injection unit and comprising means for pressurizing the airflow supplying the main vein of the injector which are controlled by electronic control means, and means for supplying the secondary vein with treatment liquid for which the volume to be distributed during a treatment operation is measured by said electronic control means.

Preferentially the electronic control means could be constituted by a microcontroller, and the means of supplying treatment liquid could be constituted by a metering pump suited to collect from the treatment liquid storage reservoir a determined volume thereof and to deliver it into a temporary storage reservoir from which it will be drawn by Venturi-effect coming from said secondary vein of the injector.

The purpose of the present invention is also the application of the misting device such as previously mentioned to the spraying of a treatment product having at least one decontamination effect in a room to be treated.

As a nonlimiting example, an embodiment of the present invention will be described below with reference to the attached drawing in which:

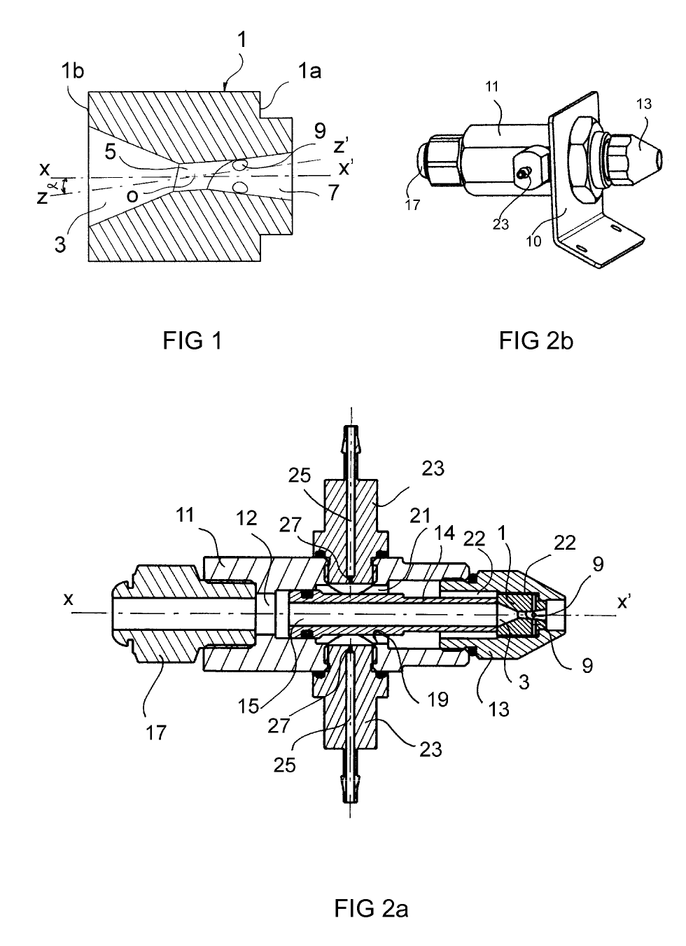

FIG. 1 is a view of a fractionating injector according to the invention in diametrical section.

FIG. 2a is a longitudinal sectional view of an injection unit used in a misting device according to the invention making use of an injector of the type of that shown in FIG. 1.

FIG. 2b is a perspective view of the injection unit shown in FIG. 2a.

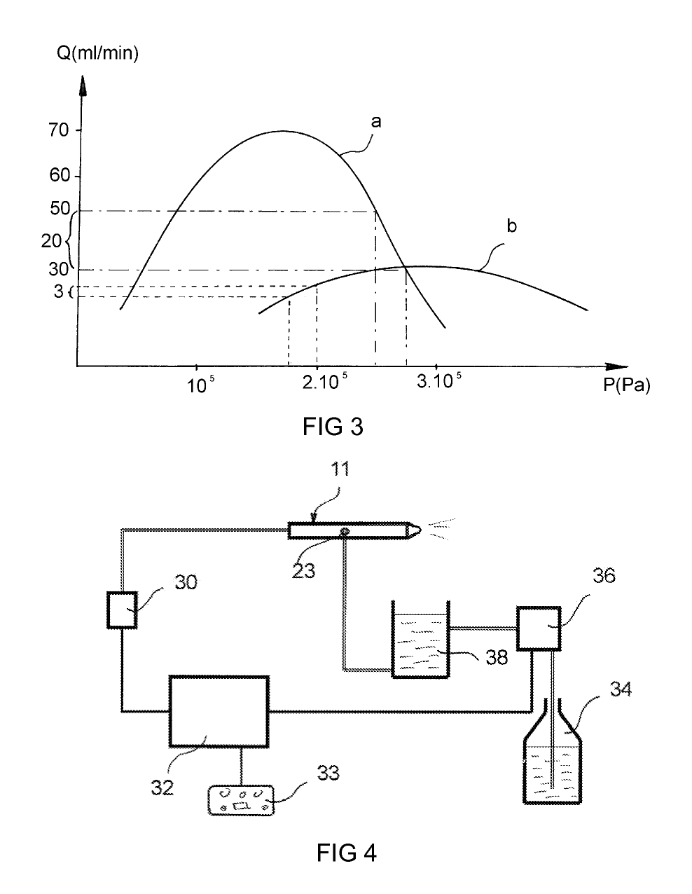

FIG. 3 is a curve showing the flow rate supplied as a function of the pressure of the propulsion gas in the main vein by an injection unit according to the prior art and by an injection device according to the invention respectively.

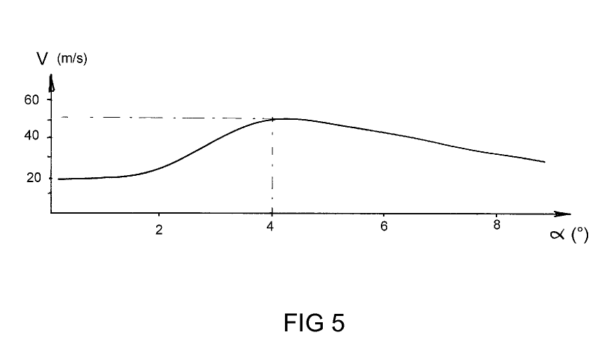

FIG. 4 is a representation in schematic form of a misting device according to the invention implementing an injection unit of the type shown in FIGS. 2a and 2b.

FIG. 5 is a curve showing the speed of the gas/liquid flow at the outlet of an injector according to the invention as a function of the angle formed between the axis of the cylindrical part thereof and the convergent and divergent longitudinal axes of the injector.

FIG. 1 shows a fractionating injector 1 according to the invention which is formed by cylindrical body with a longitudinal axis xx′ and whose anterior surface 1a has a smaller diameter. The injector 1 is traversed from one side to the other by a Venturi-type longitudinal flow vein which comprises three parts, specifically a convergent part 3, followed by a cylindrical part 5 which is extended by a divergent part 7 opening onto the outside.

In the present embodiment of the invention, the aperture of the convergent part 3 is 46° and the diameter of the inlet orifice thereof is 4.78 mm. The cylindrical part 5 extending the convergent part 3 has a diameter of 1.3 mm and the divergent part 7 extending the convergent part has an aperture of 15° and an outlet orifice of 2.27 mm.

Further the convergent part 3 and the divergent part 7 have their respective axes which are coincident with the longitudinal axis xx′ of the injector 1. For its part, the cylindrical part 5 has an axis zz′ which is angularly offset relative to the longitudinal axis xx′ and forms an angle a therewith whose value, in the present embodiment of the invention, is preferably of order 4° but which could be included, as a function of the use, between 2° and 8°. The point O, about which the axis zz′ of the cylindrical part 5 is rotated relative to the longitudinal axis xx′, is located substantially in the middle of the cylindrical part 5, and in the embodiment shown, at a distance of 4.95 mm from the upstream surface 1B of the injector 1.

The body of the injector 1 is traversed by transverse channels 9; there are four of them in the present embodiment, but a single channel or in contrast a larger number of channels could also be used. These channels 9, which open into the principal vein downstream from the cylindrical part 5 are connected with the supply and flow rate control means of the liquid that one wishes to distribute as explained below.

Thus the propellant gas, which most of the time can be constituted of air but which could also for certain specific applications be constituted by any other gas, is pressurized, for example by means of a compressor suited to apply a pressure of order 3×10⁵ Pa in the present example at the inlet to the Venturi, and then brought to the inlet of the convergent part 3 in which, in a known manner, it undergoes by Venturi effect an increase in the speed thereof and a reduction in the pressure thereof, such that at the outlet of the cylindrical part 5 the liquid to be distributed is aspirated through the transverse channels 9 in order to be sprayed in the room, mixed with the propellant gas.

According to the present invention, it was observed that surprisingly the angular offset A between the axis's zz′ of the cylindrical part 5 and the axis xx′ of the convergent part 3 and divergent part 7 has the effect of creating a particularly effective fractionating of the droplets in suspension in the gas flow.

FIGS. 2a and 2b show an injection unit making use of such a fractionating injector according to the invention.

This unit includes a body 11 on the anterior part of which is screwed an injector body 13 in which is positioned an injector 1 according to the invention, such that the longitudinal axis xx′ thereof is coincident with that of the body 11.

The injector body 11 is pierced by a central and longitudinal channel 12 in which is placed a cylindrical spacer 14 which keeps the injector 1 in position. This spacer is pierced by a central and longitudinal channel 15 with the same diameter as the inlet of the convergent part 3 and which, at one of its ends, opens therein and at the other end thereof is supplied with pressurized gas by an intake tip 17.

The median part of the body 11 is hollowed by a bore 19 making it possible to create between the inner surface thereof and the outer surface of the spacer 14 a distribution chamber 21 which is in communication by longitudinal channels 22 with the transverse channels 9 of the injector 1.

The median portion of body 1 is also pierced by transverse threaded holes into which are fixed by screwing two tubular treatment liquid supply elements 23 which are placed symmetrically relative to the longitudinal axis xx′ of the body 11. These tubular elements are pierced by a central channel 25 which opens into the distribution chamber 21 and which ends on a calibrated vein 27 making it possible to control the flow rate of the treatment liquid admitted into the distribution chamber 21. In order to make it easier to adapt the device to various treatment situations, and in particular to the specific volumes of various rooms to be treated, the two calibrated veins 27 could for example have different passage cross-section, especially of order 0.15 mm² and 0.60 mm², thus making it possible to use one or the other or both calibrated veins which makes it possible to have a total passage section of 0.15 mm², 60 mm², or 75 mm².

According to the invention, the gas arriving by the central vein traverses the convergent part 3 in which it undergoes a pressure reduction by Venturi-effect, then the cylindrical part 5 in which, because of the off-axis angle thereof, it is subject to vortices during aspiration of the liquid through the transverse channels 9 leading to a greater fractionation of the liquid admitted.

It has been observed that the fractionation thus achieved by means of the injector 1 according to the invention makes it possible to generate a mist in which the droplets forming it are of extreme fineness and additionally distribute themselves homogeneously in space so well without clumping together that they form a dry mist.

The present invention is interesting because it makes it possible to increase the liquid/gas flow speed at the outlet of the injector which has the advantage of making it possible for the flow to reach zones farther from the device and limiting or even eliminating its wetting effect. The curve in FIG. 5 shows the variation of the liquid/gas flow speed leaving the injector as a function of the angle α formed by the axis of the cylindrical part 5 of the injector with the longitudinal axis xx′ thereof. It is observed that in the present embodiment while the speed goes through a maximum for an offset α of 4° a speed increase is also obtained for offsets a included between 2° and 8°.

The present invention is also particularly interesting in that it makes it possible to reduce the pressure of the gas propelled in the principal vein, in particular because of the elimination of the resonator. Thus, when following the prior art in injection units using resonators, the optimal operating pressure in the principal vein is generally included between 2.8×10⁵ Pa and 3.2×10⁵ Pa; in the injector according to the invention, this pressure is included between 1.5×10⁵ Pa and 3.5×10⁵ Pa and preferably near 2×10⁵ Pa. It should be noted that such an arrangement has notable advantages.

In fact, it makes it possible to reduce the energy necessary and therefore the power of the means for pressurizing the gas flows admitted into the principal vein, and therefore that of the compressor used which, at the same time, makes it possible to reduce the noise thereby produced and also the bulk and cost thereof.

Furthermore it is known that in the decontamination devices according to the prior art making use of Venturi-type injection units that the value of the gas pressure, in particular the air, in the principal vein must be adjusted with great precision which, in practice, may cause serious calibration problems for installations, and means that adjustments sometimes have to be made at the sites of use. In fact, as shown on curve a from FIG. 3 which shows the variation of gas flow rate in the principal vein as a function of the pressure in this vein, it is observed that at operating pressure, which is a pressure of order 2.8×10⁵ Pa, a small pressure reduction, for example of 0.75×10⁵ Pa, moves the flow rate from a value of 30 mL/min to a value of order 50 mL/min which is a variation representing about 66% of the initial value.

In contrast, on the curve b showing the same parameters for a misting device according to the invention, a similar pressure reduction made at about the operating pressure, in other words around 2×10⁵ Pa leads to a reduction of the flow rate of order 3 mL/min which is about seven times smaller than before.

Thus, the present invention makes it possible to particularly effectively improve the uniformity of operation of the devices of this type, in particular making it possible to avoid many calibrations and adjustments which previously absolutely had to be done on site.

FIG. 4 shows in schematic form an example of a misting device implementing an injection unit making use of the fractionating injector according to the invention.

On this device the posterior part of the injection unit 11 is supplied with pressurized air by a compressor 30 which is driven by electronic control means such as in particular a microcontroller 32. This microcontroller is interfaced with control console 33 allowing the user to supply it the various parameters, such as the volume of the room, which are necessary for it to drive the treatment operations.

The treatment liquid is stored in a cartridge 34 from which the volume V determined by the microcontroller 32 to be necessary for the treatment operations to be performed is collected by means of a metering pump 36, for example a peristaltic pump, whose operation is controlled by the microcontroller 32, to be delivered into a temporary storage tank 38. The tank is joined to the inlet of the tubular elements 23. When the desired volume V has been transferred into the tank 38, the microcontroller 32 orders compressor 30 to start in order to begin treatment and, when the reservoir 38 has been emptied, the microcontroller shuts it off.

Of course the injector according to the invention could be used with decontamination devices with different structure and layouts. It could also find applications in other domains than that of decontamination, and could be used in conjunction with the most varied applications where it is necessary to generate miniscule droplets suitable for forming a dry mist.

1. A fractionating injector in particular for a Venturi-effect misting unit, of the type comprising a main vein successively constituted of a convergent axial vein (3) intended to receive a pressurized gas flow, a cylindrical vein (5) and a divergent axial vein (7), where said injector comprises furthermore at least one secondary vein (9), substantially transverse, intended to admit a flow of treatment liquid and which opens out downstream from the convergent vein (3), characterized in that the axis (zz′) of the cylindrical vein (5) is offset in angle relative to the longitudinal axis (xx′) of the convergent (3) and divergent (5) veins.

2. Fractionating injector according to claim 1, characterized in that the secondary vein (9) opens out into the upstream part of the divergent vein (7).

3. Fractionating injector according to one of claim 1 or 2, characterized in that angular offset (α) is included between 2° and 8° and is preferably equal to about 4°.

4. Fractionating injector according to one of claims 1 to 3, characterized in that the respective lengths of the convergent vein (3) and divergent vein (7) are substantially equal.

5. Fractionating injector according to one of claims 1 to 4, characterized in that the length of the cylindrical vein (5) is equal to about half the length of the convergent vein (3) and, more precisely, of order 0.4 times the length.

6. Fractionating injector according to one of claims 1 to 5, characterized in that the aperture of the convergent vein (3) is included between 40° and 50° and preferably near 46°.

7. Fractionating injector according to one of claims 1 to 6, characterized in that the aperture of the divergent vein (5) is included between 10° and 20° and preferably near 15°.

8. Fractionating injector according to one of claims 1 to 7, characterized in that the diameter of the cylindrical vein is included between 0.9 and 1.5 mm and preferentially near 1.3 mm.

9. An injection unit of the type comprising a body (11) pierced by a cylindrical axial channel (15) supplied, at one of the ends thereof, by a pressurized gas flow and receiving at the other end thereof a fractionating injector (1) according to one of claims 1 to 8, where said body is provided with at least one line (23) for intake of a treatment liquid opening out into a distribution chamber (21) connected with the secondary vein (9) of the injector (1).

10. Injection device according to claim 9, characterized in that the axis of the intake line (23) is substantially perpendicular to the longitudinal axis (xx′) of the axial channel (15).

11. Injection device according to one of claim 9 or 10, characterized in that the line for intake of the treatment liquid is provided in the downstream part thereof with a calibrated orifice (27) for flow rate control.

12. Injection device according to one of claims 9 to 11, characterized in that the distribution chamber (21) is formed between the outer surface of an insert (14) bearing on the injector (1) which will be pierced by an axial channel for supply thereof by gas flow and the inner surface of a recess (19) made in the body (11).

13. A misting device comprising a fractionating injector according to one of claims 1 to 8, placed in an injection unit according to one of claims 9 to 11, and comprising means for pressurizing (3) the airflow supplying the main vein of the injector (1) which are controlled by electronic control means (32), and means for supplying (36, 38) the secondary vein (9) with treatment liquid for which the volume (V) to be distributed during a treatment operation is measured by said electronic control means (32).

14. Misting device according to claim 13, characterized in that the electronic control means are constituted by a microcontroller (32).

15. Misting device according to one of claim 13 or 14, characterized in that the means of supplying treatment liquid are constituted by a metering pump (36) suited to collect from a treatment liquid storage reservoir a determined volume (V) thereof and to deliver it into a temporary storage reservoir (38) from which it will be drawn by Venturi effect coming from said secondary vein (9) of the injector (1).

16. An application of a misting device according to one of claims 13 to 15 to the spraying of a treatment product having at least one decontamination effect in a room to be treated.
